(19) United States
(12) Patent Application Publication
(10) Pub. No.: US 2008/0124110 A1
(43) Pub. Date: May 29, 2008

(54) Image Forming Device Component

(76) Inventors: Douglas Campbell Hamilton, Lexington, KY (US); Jerry Wayne Smith, Irvine, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/564,413

(22) Filed: Nov. 29, 2006

(51) Int. Cl. G03G 15/20

(52) U.S. Cl. 399/69; 399/333

(57) ABSTRACT

The present disclosure relates to a system including a component and a heating device. The component may include a compressible layer composed of elastomeric material having a thermal conductivity of ≦0.4 W m⁻¹K⁻¹. A processor in communication with the heating device, may he configured to select the heating device temperature based upon a previous temperature of the heating device to establish the temperature of the component. Optionally, the component may be maintained at a temperature of about or below 150° C.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present application relates to a system including a component and a heating element in a fuser having controlled temperature management. In particular, the component may be a backup roller including an elastomeric material having a selected thermal conductivity. The system may be employed in an image forming device.

2. Description of the Related Art

Many image forming devices utilize fusers, which may include a component and a heating element to fuse an image forming substance or a developing agent, e.g. toner, to a sheet of media via heat and/or pressure developed by the heating element and the component is the fuser. In such a manner, the heating element and the component may form a nip through which media may pass. The thickness of the nip and pressure applied to the media in the nip may affect printing speeds and may be regulated by factors such as the operating temperature of the component, compression strength of the component, or ability of the component to deform and the creep and stress relaxation characteristics of the component.

### SUMMARY OF THE INVENTION

An exemplary embodiment relates to a system for setting a temperature of a heating device during a print job. The system may include a component comprising a compressible layer composed of elastomeric material having a thermal conductivity of ≦0.4 W m⁻¹K⁻¹. A heating device may then be provided that includes a temperature detecting device and a processor in communication with the heating device. The processor may be configured to select the heating device temperature based upon a previous temperature of the heating device to establish the temperature of the component.

### BRIEF DESCRIPTION OF THE DRAWINGS

The above-mentioned and other features and advantages of this invention, and the manner of attaining them, will become more apparent, and the invention will be better understood by reference to the following description of embodiments of the invention taken in conjunction with the accompanying drawings, wherein:

FIG. 1 is a perspective view of an exemplary embodiment of a component such as a back-up roller for use with a fuser;

FIG. 2 is a cross-sectional view of an exemplary embodiment of a component illustrating voids therein;

FIG. 3 is a side view of an exemplary fuser including a component and a heating device;

FIGS. 4, 5a and 5b is an exemplary flow diagram of an exemplary system, of managing the component temperature;

FIG. 6 is an illustration of an embodiment of an article of machine readable media in relation to a processor and a user interface; and

FIG. 7 is an illustration of an exemplary system including an article of machine readable media in relation to a processor and a fuser.

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

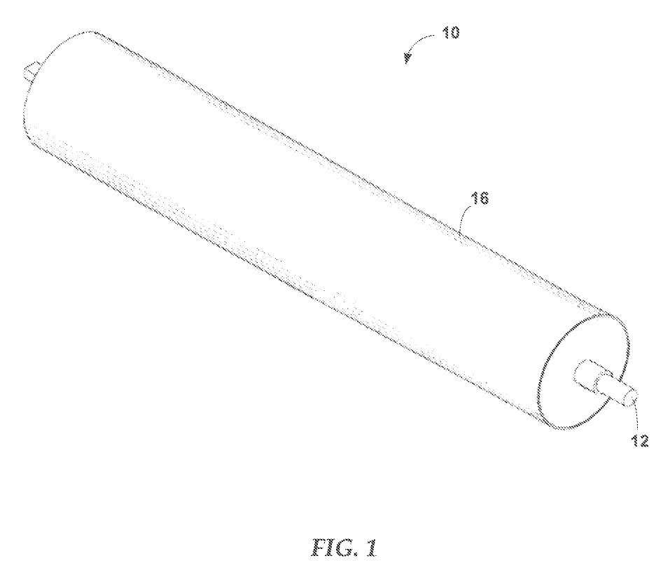

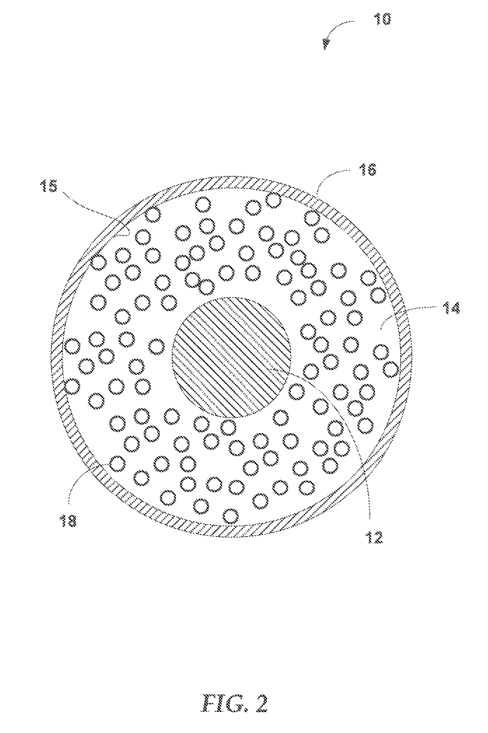

The present application relates to a system including a component having discrete voids therein for use in a fuser and/or an image forming apparatus. The system may manage the temperature of the fuser so as to regulate the component temperature, such that the component does not exceed about 150° C., illustrated in FIGS. 1 and 2 is an exemplary component 10. The component may include a shaft 12, a compressible layer 14 surrounding the shaft 12 and a release layer 16 coating the periphery of the compressible layer 15. Voids 18 may be located in the compressible layer and may comprise preformed hollow spheres.

The shaft 12 may be composed of a conductive or non-conductive material. The shaft may be metallic (i.e., aluminum, stainless steel, copper, etc.) or polymeric (either thermoset or thermoplastic). The compressible layer 14 may be molded over the shaft 12, coated over the shaft or fit over the shaft. In addition, an adhesive (not illustrated) may be applied to the shaft to affix the compressible layer to the shaft.

The compressible layer 14 may be composed of an elastomeric material having reduced thermal conductivity. For example, the elastomeric material may contain voids 18. Voids may be understood herein as voids that are individually contained and not open or connected to other voids. Elastomeric material may be understood as material exhibiting elastic properties and capable of substantially returning to its original shape (≦90%) when an applied load is removed. The material may also be thermoset or thermoplastic. Exemplary elastomers may include natural rubber, polyisoprene, silicone, etc. An exemplary silicone polymer may include polysiloxane material, such as poly(dimethylsiloxane) or PDMS. The compressible layer may have a thermal conductivity of less than or equal to about 0.4 W m⁻¹K⁻¹, including all values and ranges therein, such as 0.2 W m⁻¹K⁻¹, 0.15 W m⁻¹K⁻¹, etc. The compressible layer herein may specifically have a thickness of equal to or greater than about 3.5 mm. In addition, the thickness may be in the range of about 3.5 mm to 10.0 mm, including all values and ranges therein,

The voids may be formed using preformed hollow microspheres or they may be produced by a blowing agent contained in the rubber which may be converted into a gas and provide void formation when the rubber is cured. The voids may have a thermal conducvity of less than or about 0.3 W m⁻¹K⁻¹, including all increments and values therein, such as in the range of 0.01 W m⁻¹K⁻¹ to 0.3 W m⁻¹K⁻¹. The microspheres maybe composed of glass, resin (thermoplastic or thermoset), ceramics, silicates, etc. In addition, the microspheres may include a surface coating which may aid in dispersing the microspheres through the compressible layer. It should be appreciated that the compressible layer may include an additive which may aid in dispersion of the microspheres.

The compressible layer 14 may ultimately include microspheres 18 in the range of 10%-90% by weight (wt.) of the compressible material, including all values and increments therebetween. The voids maybe in the range of about 1 to 1,000 microns in diameter. The microsphere may also have an average wall thickness of between 1% to 50% of the sphere diameter, including all ranges and increments therein. The microsphere may also have a thermal conductivity of 0.01 to 0.3 Wm⁻¹K⁻¹ and a softening temperature in the range of 50 to 1500° C. and a melting temperature in the range of 100 to 1500° C. In addition, the microsphere may have a particle density of about 0.010 to 1.00 grams per cubic centimeter, including all values and increments therebetween. The microspheres may have a hardness in the range of 3 to 7 on the Mohs hardness scale, including all values and increments therein and a crush strength of 50 to 400 kg/cm².

It should be appreciated that while forming the compressible layer 14, the integrity of the microspheres 18 may he maintained. Therefore at least 50% of the microspheres must remain intact, such as between 75% to 99% of the microspheres, including all ranges and increments therein. In addition, it should be appreciated that the compressible material including the voids may have a thermal conductivity of less than or about 0.4 W m⁻¹K⁻¹, including all increments and values therein.

The release layer 16 may be composed of a fluoro-polymer or copolymer. Exemplary fluoropolymers include perfluoroalkoxyl (PFA), modified fluoroalkoxyl (MPA), polytetrafluoroethylene (PTFE), as well as fluoro-polymer blends and copolymers. The release layer may he coated onto the compressible material as a fluoropolymer latex, wherein, for example, PTFE or PFA may be provided in an aqueous solution. Exemplary coating methods may include spray coating, dip coating, etc. In addition, the release layer may be formed into a sleeve and the sleeve may be fit over or molded onto the compressible layer. The release layer may be less than or equal to about 30-50 microns and preferably between 0.1 to 50 microns, including all values and increments therein, such as less than 30 microns, 10 microns, etc. The surface baldness of the component may be less than about 65 on the Shore Durometer D Scale, such as between 10 and 65, including all values and increments therein such as between 30 and 50, 40, 25, etc.

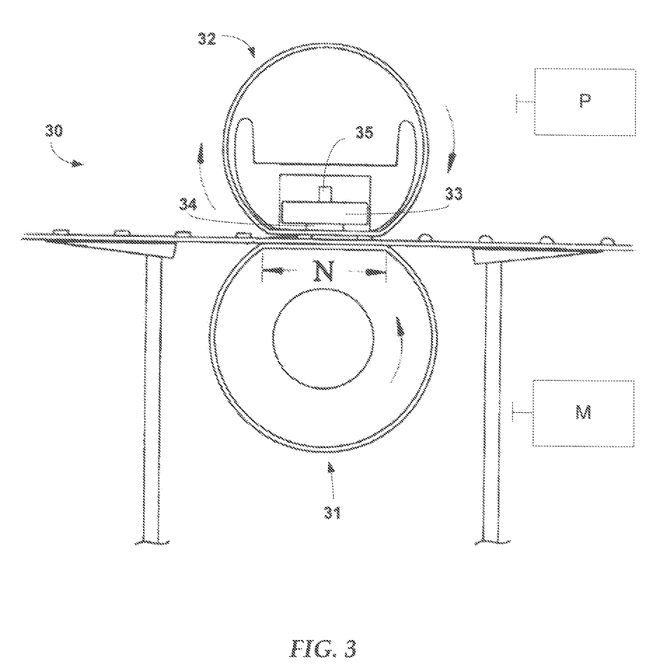

An exemplary fuser is depicted in FIG. 3. The fuser 30 may include the component described herein 31 and a heating device 32. The fuser may be a belt fuser as illustrated or a hot roll fuser (not illustrated). A nip N may be formed between the component 31 and the heating device 32. The nip width being a function of parameters such as surface hardness, compression modulus and nip pressure. A motor M may also be provided which may drive the media through the nip in conjunction with the heating device 32 and the component 31. In addition, the fuser may be included in an image forming device. Exemplary image forming devices may include primers, copiers, faxes, all-in-one machines, multi-functional machines, etc.

The heating device 32 may include a heater substrate 33, an electrical resistor 34 for generating heat, and a temperature detecting element 35. The electrical resistor 34 may extend a portion of or the entire length of the heater substrate 33. The temperature detecting element 35 may include a thermostat or thermistor and may be mounted in contact with the heater substrate 33.

The component 31 which is illustrated as a back-up roller in combination with the heating device (e.g. fuser) may be capable of a nip force of less than 30 lbs having a warm-up time of less than 8 seconds and capable of a printing speed greater than 32 pages per minute. In addition, the component 31, which as noted above may have a thickness of ≧3.5 mm, may be maintained in the system at a temperature of less than or equal to about 150° C. it should be appreciated that the temperature of the component 31 may he regulated by the temperature of the heating device, as thermal transfer between the component and the heating device may occur. Some of the thermal energy, however, may be transferred from the backup roller when media is passing through the nip. However, if the backup roller is in direct contact with the heating device in the fuser, there may be a decrease in the dissipation of the thermal energy.

The heating device may communicate with a processor P. The processor may include a microprocessor or other processor located within the fuser, image forming device or another host device, such as a computer. The processor may include software, firmware or hardware. When a print job is generated, the processor may recognize that there may be a print job to be printed and the properties of print job that may be printed. The processor may also be capable of maintaining a page count. A page count may be understood herein as the number of pages printed in a single print job or the number of pages printed in a number of print jobs that may be run in succession. The page count may be cleared or returned to zero at either the end or beginning of a single print job or a number of print jobs. The processor P may also communicate with the motor M to determine whether the motor is running, which may indicate that media was recently or is being fed through the fuser.

A print job as understood herein may refer to information or images, such as text, characters or graphics, that may be printed on at least one sheet of media. Print job properties may refer to the type of media chosen, the size of media chosen, the type of developing agent or toner, e.g. the type of toner and its associated optimum fusing temperature. In addition, print job information may also include the number of sheets or pages and whether the print job is a simplex or a duplex. A simplex print job may be understood herein wherein only one side of a page may he printed on. A duplex may be understood herein wherein both sides of a page may be printed on.

When pauses occur between pages in a print job, the fuser may turn off and cool. For example, there may he pauses in between individual pages when several short print jobs are processed or there may be pauses between fusing the front and back portions of a page during a duplex operation. However, at the end of these pauses, the fuser may turn back on again and the temperature of the fuser may ramp-up accordingly. Repeated ramp-ups of the fuser may cause a build-up of energy in the backup roller as a portion of the thermal energy may not dissipate from the backup roller, particularly when media is not being fed through the fuser.

In an exemplary embodiment a system may be provided wherein the beating device temperature, and therefore the component, temperature, may be regulated based on factors such as the heating device temperature prior to, or at the beginning of a print job, the number of pages that may have been counted by the processor, whether simplex or duplex printing operations are being processed, or whether the motor for feeding media may be running.

Utilizing a number of look-up tables, which may correlate the above described factors, as well as other device specific factors, such as media throughput, the processor may determine the operating temperature of the fuser or the amount of thermal energy which may be necessary to beat the backup roller without overheating it. Accordingly, should it be determined that the fuser may be ramping up to a desired temperature from a cold start, wherein the backup roller may be relatively cool, a temperature may be chosen from a cold start table. Once again, the temperature chosen from the cold start table may also be based on the type of media, throughput, etc.

Should it be determined that the fuser may be ramping up to a desired temperature from a warm start or a hot start, wherein the backup roll may be warm or at an operating temperature, different look-up tables for a warm start or hot start may be utilized. In such a manner, a warm start may be determined when the motor is running or the page count is relatively high, wherein less thermal energy may be necessary to heat the backup roll then when the motor is not running or the page count is relatively low. In addition, a hot start may occur when the processor determines that the page count may be relatively high, the motor is running and the fuser is still at a relatively high temperature.

Accordingly, a greater amount of thermal energy may be placed into the fuser, and therefore the backup roller, when the processor has determined that a cold start occurs as compared to when a warm or hot start occurs, prevent the overheating of the backup roll. In such a manner the temperature of the backup roll may be regulated and maintained at less than or about 150° C. indirectly through the management of the fuser temperature.

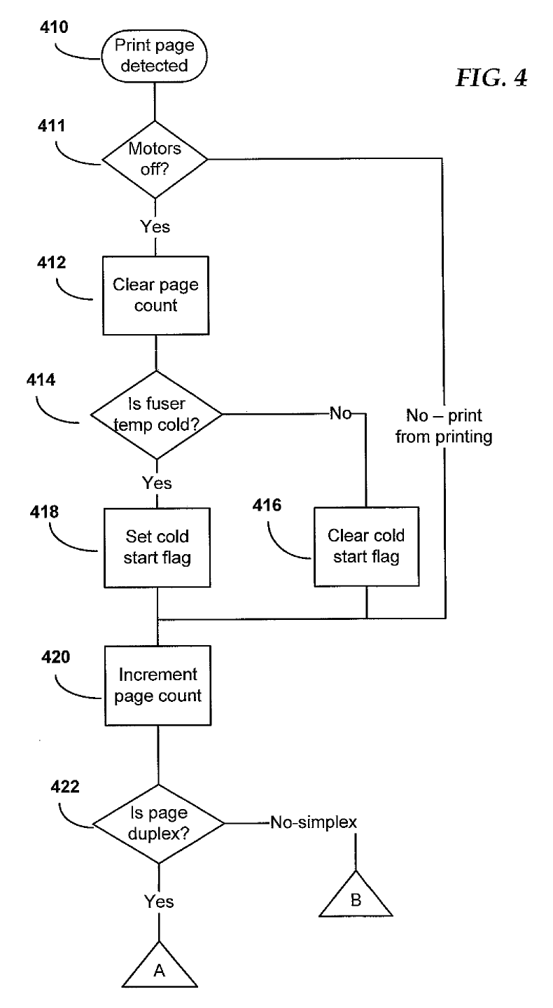

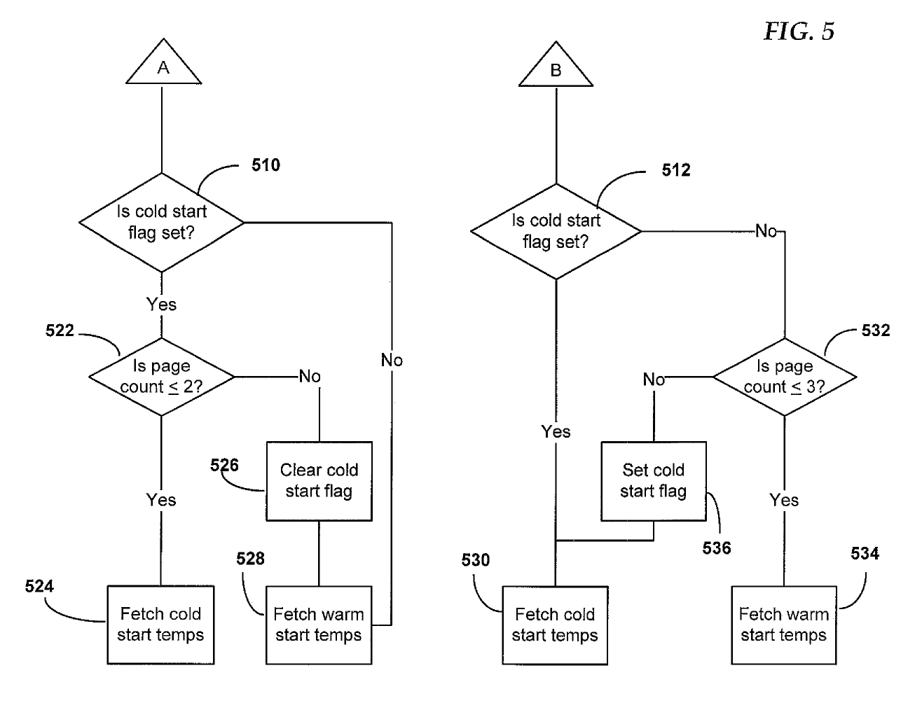

A system may therefore be provided as illustrated in FIGS. 4, 5a and 5b wherein a processor may receive a print job 410 and detects that at least one page will be printed. At 411 a determination may be made as to whether the feeding and/or transfer motor may have been turned off. If the motors have been turned off, the page count may be cleared at 412. The processor may also receive input from the temperature sensing element and may determine whether the heating device is above or below a specified temperature at 414. If the heating device temperature is above a given set point then a there may be an indication set, such as clearing a cold start flag or pointer, signifying that the heating device is above the specified temperature 416. If the heating device temperature is below the given specified temperature at 414 then an indication, such as setting a cold start flag or pointer, signifying that the heating device is below the specified temperature may be given at 418.

The page count may be incremented at 420, and a determination may be made as to whether the print job will be a simplex or a duplex operation 422. If a duplex operation is contemplated then as illustrated in FIG. 5a, a determination as to whether the cold start flag has been set or cleared at 510. If the cold start flag has been set then the processor may determine the number of pages processed and whether the page count is above or below a given number 522. If the page count is below a given number then a cold start temperature may be selected from a look-up table 524. If the page count is above a given number (2 is used in this example, however any number in the range of 1 and 50 may be selected) then the cold start flag may be cleared at 526 and temperatures may he selected from a warm temperature look-up table 528.

If the printing operation is a simplex operation then, as illustrated in FIG. 5b, a determination may be made as to whether a cold start flag is set at 512. If the cold start flag is set, then temperatures may be selected from a cold start temperature look-up table at 530. If the cold start flag is not set then the page count may be examined at 532. If the page count is below or equal to a given number at 532, the cold start flag may be set at 536 and a temperature may be selected from the cold start look-up table. If the page count is above a given number then a temperature may be selected from a warm start look-up table at 534. By selecting appropriate temperatures, overheating of the backup roller may be prevented and the temperature of the backup roller may be maintained at less that 150° C.

It should be appreciated that, while the above, describes the use of two look-up tables, more than two tables may be provided. Each look-up table may include a number of temperature settings based on the fuser, image forming device, media employed, such as throughput, media type or developing agent type. The look-up tables may be stored in memory hardware, software or firmware in the fuser, image forming device or a host device in communication with the fuser or image forming device.

It should also be appreciated that the functionality described herein for the embodiments of the present invention may be implemented by using hardware, software, firmware or a combination thereof, either within the processor, image forming device, a computer or other device, as desired. If implemented by software, a processor and a machine readable medium are required. The processor may be of any type of processor capable of providing the speed and functionality required by the embodiments of the invention. Machine-readable medium may includes any memory capable of storing instructions adapted to be executed by a processor. Some examples of such memory include, but are not limited to, read-only memory (ROM), random-access memory (RAM), programmable ROM (PROM), erasable programmable ROM (EPROM), electronically erasable programmable ROM (EEPROM), dynamic RAM (DRAM), magnetic disk (e.g., floppy disk and hard drive), optical disk (e.g. CD-ROM), and any other device that may store digital information. The instructions may be stored on medium in either a compressed and/or encrypted format.

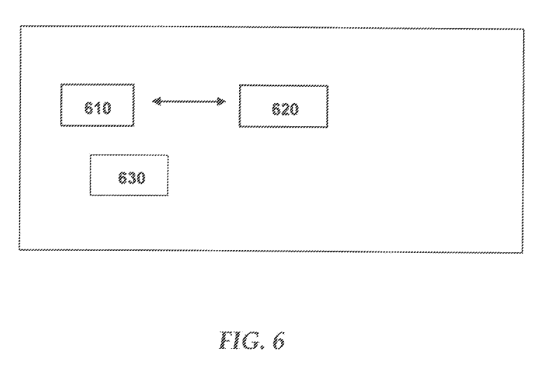

Accordingly, in the broad context of the present invention, and with attention to FIG. 6, an image forming device, for example, may contain a processor 610 and machine readable media 620 and user interface 630. It should be appreciated that the user interlace may be any interface that the user has with the fuser, image forming device, host device or any device that may be in communication with the fuser or image forming device in which the user may input information such a print job.

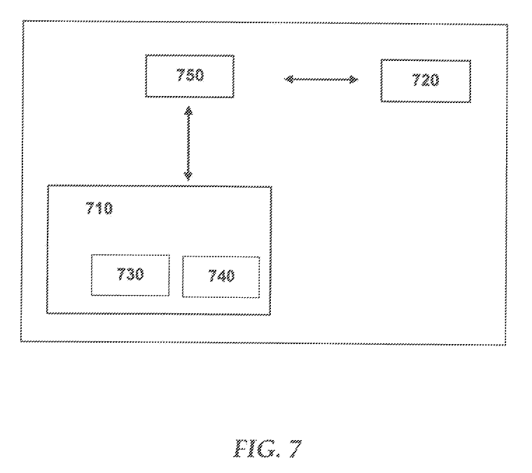

Accordingly, the system may be a combination of the article of machine readable media including instructions thereon which may provide the functionality described herein in combination with the component as used in a fuser. Thus, in the broad context of the present invention, and with attention to FIG. 7, a system may be provided wherein a fuser 710 may receive instructions as provided by the machine readable media 720 for controlling the temperature of the backup roller 730 via thermal management of the beating device 740. In addition, the instructions from the machine readable media 720 may be presented to the fuser 710 via a processor 750 as illustrated.

The foregoing description of several methods and an embodiment of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. A system for setting a temperature of a heating device during a print job comprising:
a component comprising a compressible layer composed of elastomeric material having a thermal conductivity of ≦0.4 W m⁻¹K⁻¹;
a heating device comprising a temperature detecting device; and
a processor in communication with said heating device, wherein, said processor is configured to select said heating device temperature based upon a previous temperature of said heating device to establish the temperature of said component.

2. The system of claim 1 wherein said elastomeric material includes voids.

3. The system of claim 2 wherein said voids have a thermal conductivity of ≦0.3 Wm⁻¹ K⁻¹.

4. The system of claim 1 wherein said elastomer comprises a polysiloxane having a thermal conductivity of ≦0.2 W m⁻¹K⁻¹.

5. The system of claim 4 wherein said polysiloxane includes voids.

6. The system of claim 1 wherein said processor is further configured to:
access a plurality of look-up tables;
reference at least one of said plurality of look-up tables based on said previous temperature of said beating device.

7. The system of claim 1 wherein said component is maintained at a temperature of about or below 150° C.

8. The system of claim 1 wherein said voids comprise microspheres.

9. The system of claim 1 wherein said compressible layer includes a surface and said component comprises a release layer covering at least a portion of said surface.

10. The system of claim 9 wherein said release layer comprises a fluoropolymer.

11. The system of claim 1 wherein said compressible layer is mounted on at least a portion of a shaft.

12. The system of claim 1 wherein said processor is further configured to maintain a page count and set said heating device temperature based on said page count and said previous temperature.

13. The system of claim 1 wherein said processor is further configured to determine if a motor is running and is capable of setting said heating device temperature based on whether said motor is running and said previous temperature.

14. The system of claim 1 wherein said processor is further configured to determine said heating device temperature based upon one or more of the following factors: media type, media size, media throughput rate, developing agent or toner, or whether the print job is a simplex or duplex.

15. An image forming device comprising:
a component comprising a compressible layer composed of elastomeric material having a thermal conductivity of ≦0.4 W m⁻¹K⁻¹;
a heating device comprising a temperature detecting device; and
a processor in communication with said heating device, wherein said processor is configured to select said heating device temperature based upon a previous temperature of said heating device to establish the temperature of said component.

16. The image forming device of claim 15 wherein said elastomeric material includes voids.

17. The image forming device of claim 16 wherein said voids have a thermal conductivity of ≦0.3 Wm⁻¹K⁻¹.

18. The image forming device of claim 15 wherein said processor is further configured to:
access a plurality of look-up tables;
reference at least one of said plurality of look-up tables based on said previous temperature of said beating device.

19. The image forming device of claim 15 wherein said component is maintained at a temperature of about or below 150° C.

20. The image forming device of claim 15 wherein said voids comprise microspheres.

21. The image forming device of claim 15 wherein said compressible layer includes a surface and said component comprises a release layer covering at least a portion of said surface.

22. The image forming device of claim 21 wherein said release layer comprises a fluoropolymer.

23. The image forming device of claim 15 wherein said compressible layer is mounted on at least a portion of a shaft.

24. The image forming device of claim 15 wherein said processor is further configured to maintain a page count and set said heating device temperature based on said page count and said previous temperature.

25. The image forming device of claim 15 wherein said processor is further configured to determine if a motor is running and is capable of setting said heating device temperature based on whether said motor is running and said previous temperature.

26. The image forming device of claim 15 wherein said processor is further configured to determine said heating device temperature based upon one or more of the following factors: media type, media size, media throughput rate, developing agent or toner, or whether the print job is a simplex or duplex.
